(19) United States
(12) Patent Application Publication
(10) Pub. No.: US 2015/0193728 A1
(43) Pub. Date: Jul. 9, 2015

(54) COMPUTING DEVICE AND METHOD FOR AUTOMATICALLY PROCESSING PRODUCT CHANGE NOTICE OF ELECTRONIC PRODUCTS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HAI-QING ZHOU, Shenzhen (CN); YI-XIN TU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 14/150,718

(22) Filed: Jan. 8, 2014

(51) Int. Cl. G06Q 10/08

(52) U.S. Cl. CPC G06Q 10/087

(57) ABSTRACT

In a method for automatically processing product change notice (PCN) of electronic products using a computing device, the computing device connects to a PCN database and a product design management (PDM) database through a network. PCN information of the electronic products are collected from suppliers and stored in the PCN database. A bill of materials (BOM) of each electronic product is created in the PDM database. PCN information of the electronic products is searched from the PCN database at a regular time interval. The BOM of a corresponding electronic product is searched from the PDM database according to a product ID obtained from the PCN information, and the product information of the electronic product is updated in the BOM. The PCN information of the electronic product is displayed on an electronic bulletin board to monitor the PCN information of the electronic product.

### BACKGROUND

1. Technical Field

Embodiments of the present disclosure relate to information processing systems and methods, and particularly to a computing device and a method for automatically processing a product change notice (PCN) of electronic products.

2. Description of Related Art

Bill of materials (BOMs) are usually generated during a manufacturing process of electronic products, and used to store a large amount of data, such as characteristic data of the electronic products. However, if a supplier sends a product change notice (PCN) to update the BOM of an electronic product, an operator may need to manually update the BOM, such as change characteristic data of the electronic product according to the PCN. However, manual processing of the BOMs is costly and inefficient. Therefore, there is a need for a method and system for automatically processing PCN information of electronic products.

### BRIEF DESCRIPTION OF THE DRAWINGS

FIG. 1 is a block diagram of one embodiment of a computing device comprising a product change notice (PCN) processing system.

FIG. 2 is a flowchart of one embodiment of a method for automatically processing PCN of electronic products.

FIG. 3 is a schematic diagram of one embodiment of a bill of materials (BOM) of an electronic product.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable media or storage medium. Some non-limiting examples of a non-transitory computer-readable medium comprise CDs, DVDs, flash memory, and hard disk drives.

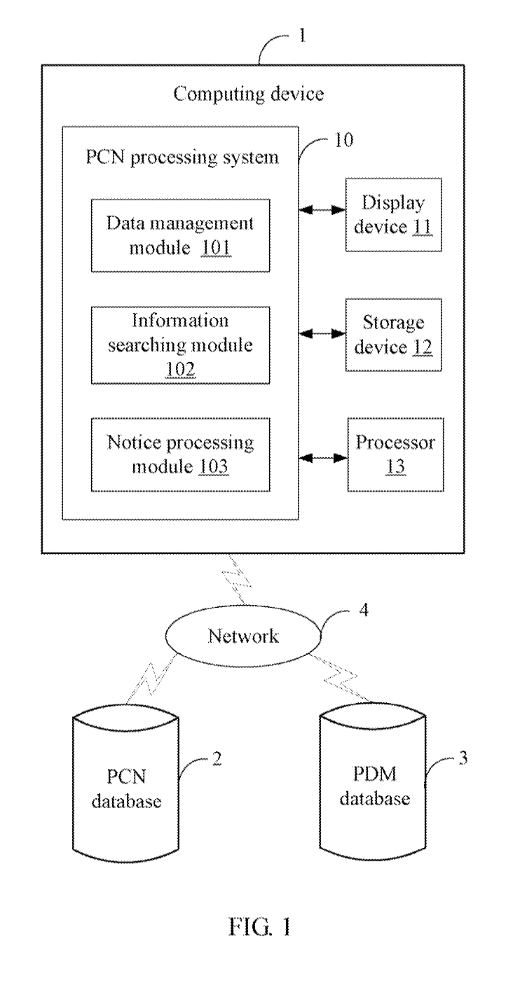

FIG. 1 is a block diagram of one embodiment of a computing device 1 comprising a product change notice (PCN) processing system 10. In the embodiment, the computing device 1 further comprises, but is not limited to, a display device 11, a storage device 12, and at least one processor 13. The PCN processing system 10 comprises computerized instructions in the form of one or more computer-readable programs, which are implemented by the at least one processor 13 of the computing device 1. In one embodiment, the computing device 1 can be a personal computer, a server computer, a workstation computer, or other suitable data processing device. FIG. 1 is only one example of the computing device 1, and other examples may comprise more or fewer components than those shown in the embodiment, or have a different configuration of the various components.

In the embodiment, the computing device 1 connects to a PCN database 2 and a product design management (PDM) database 3 through a network 4. The PCN database 2 stores PCN information of electronic products. The PCN information is sent by a supplier of the electronic products. The PCN information of each electronic product may comprise a supplier ID, a product ID, a product name, and product change data. The electronic products can be, but are not limited to, motherboards, CPUs, memories, resistors, and capacitors. The PDM database 3 stores a bill of materials (BOM) of each electronic product. The BOM comprises product design data of each electronic product. The product design data of each electronic product may comprise a product ID, a product name, a supplier ID, and product characteristic data of the electronic product. The network 4 may be a local area network (LAN) or a wide area network (WAN), such as an intranet or the Internet.

The display device 11 displays an electronic bulletin board that displays the PCN information of the electronic products. In one embodiment, the storage device 12 can be an internal storage system, such as a flash memory, a random access memory (RAM) for temporary storage of information, and/or a read-only memory (ROM) for permanent storage of information. The storage device 12 can also be an external storage system, such as an external hard disk, a storage card, or a data storage medium. The at least one processor 13 can be a central processing unit (CPU), a microprocessor, or other suitable data processor chip that performs various functions of the computing device 1.

The PCN processing system 10 searches PCN information of an electronic product from the PCN database 2 when a PCN of the electronic product is received from the supplier, and automatically updates product characteristic data of the BOM of the electronic product stored in the PDM database 3 according to the PCN information. In one embodiment, the PCN processing system 10 comprises, but is not limited to, a data management module 101, an information searching module 102, and a notice processing module 103. The modules 101-103 may comprise computerized instructions in the form of one or more computer-readable programs that are stored in a non-transitory computer-readable medium (such as the storage device 12) and executed by the at least one processor 13 of the computing device 1. A description of each module is given in the following paragraphs.

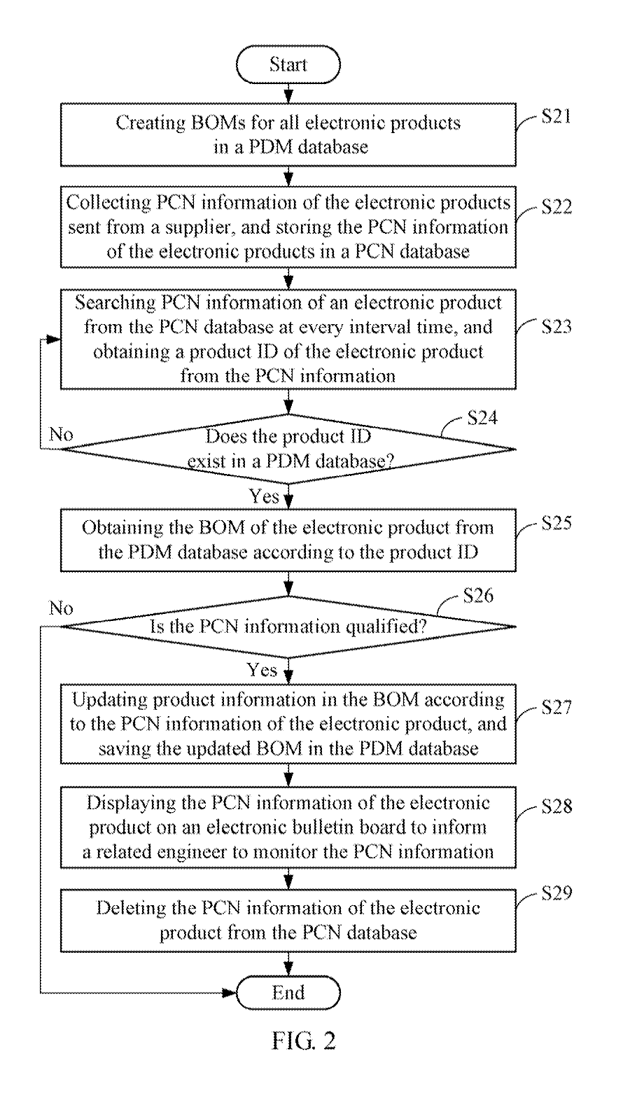

FIG. 2 is a flowchart of one embodiment of a method for automatically processing PCN of electronic products. In one embodiment, the method is performed by execution of computer-readable software program codes or instructions by the at least one processor 13 of the computing device 1. Depending on the embodiment, additional steps may be added, others removed, and the ordering of the steps may be changed.

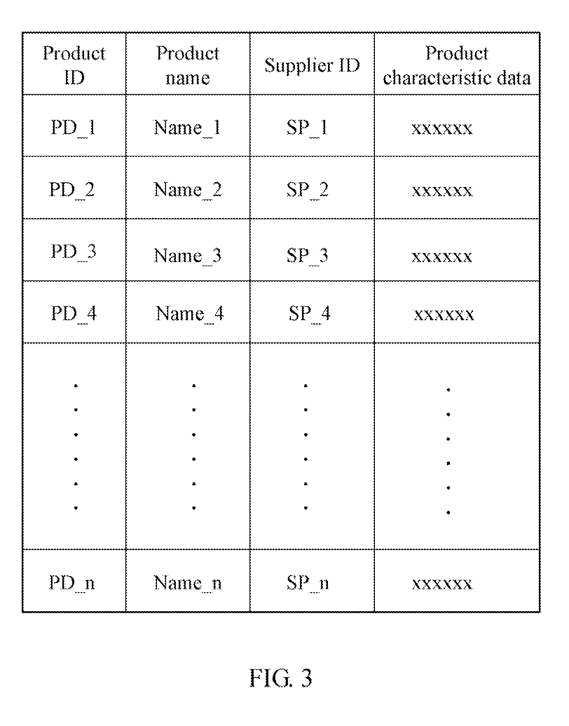

In step S21, the data management module 101 creates BOMs for all electronic products in the PDM database 3. Referring to FIG. 3, the BOM of each electronic product stores product design data of the electronic product. In one embodiment, the product design data of each electronic product comprises a product ID, a product name, a supplier ID, and product characteristic data of the electronic product.

In step S22, the data management module 101 collects PCN information of the electronic products sent from a supplier, and stores the PCN information of the electronic products in the PCN database 2. In the embodiment, the PCN information of each electronic product comprises a supplier ID, a product ID, a product name, and product change data.

In step S23, the information searching module 102 searches PCN information of each electronic product from the PCN database 2 at a regular time interval, and obtains a corresponding product ID of the electronic product from the PCN information. In one embodiment, the time interval is set according to manufacturing requirements. For example, if the time interval is set to once a day, such as at two o'clock every day, the PCN information of the electronic product is obtained from the PCN database at two o'clock every day.

In step S24, the information searching module 102 determines whether the product ID of the electronic product exists in the PDM database 3. If the product ID of the electronic product exists in the PDM database 3, step S25 is implemented. Otherwise, if the product ID of the electronic product does not exist in the PDM database 3, the process goes back to step S23.

In step S25, the information searching module 102 obtains the BOM of the electronic product from the PDM database 3 according to the product ID, and reads product information of the electronic product from the BOM of the electronic product. Referring to FIG. 3, the product information of each product comprises a product ID (e.g., PD_1), a product name (e.g., Name_1), a supplier ID (e.g., SP_1), and product characteristic data.

In step S26, the notice processing module 103 determines whether the PCN information of the electronic product is qualified according to the product information of the BOM. In the embodiment, if the PCN information of the electronic product comply with manufacturing standards of the electronic product, the PCN information of the electronic product is determined to be qualified. If the PCN information of the electronic product is qualified, step S27 is implemented. Otherwise, if the PCN information of the electronic product is unqualified, the process ends.

In step S27, the notice processing module 103 updates the product information in the BOM according to the PCN information of the electronic product, and saves the updated BOM in the PDM database 3. In the embodiment, the product information of the BOM is synchronously updated in the PDM database 3 according to the corresponding PCN information of the electronic product stored in the PCN database 2.

In step S28, the notice processing module 103 displays the PCN information of the electronic product on an electronic bulletin board to monitor the PCN information of the electronic product. In the embodiment, the electronic bulletin board is displayed on the display device 3 for showing the PCN information to efficiently monitor the PCN information of the electronic products sent from the corresponding suppliers.

In step S29, the notice processing module 103 deletes the processed PCN information of the electronic product from the PCN database 2, to save storage space of the PCN database 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device connected to a product change notice (PCN) database and a product design management (PDM) database, the computing device comprising:
at least one processor; and
a storage device storing a computer-readable program comprising instructions that, which when executed by the at least one processor, causes the at least one processor to:
create bill of materials (BOMs) for all electronic products in the PDM database;
collect PCN information of the electronic products sent from a supplier, and store the PCN information of the electronic products in the PCN database;
search PCN information of an electronic product from the PCN database at a regular time interval, and obtain a product ID of the electronic product from the PCN information;
determine whether the product ID of the electronic product exists in the PDM database;
obtain a BOM of the electronic product from the PDM database according to the product ID when the product ID of the electronic product exists in the PDM database;
determine whether the PCN information of the electronic product is qualified according to product information of the electronic product stored in the BOM;
update the product information of the electronic product stored in the BOM according to the PCN information of the electronic product and save the updated BOM in the PDM database when the PCN information of the electronic product is qualified; and
display the PCN information of the electronic product on an electronic bulletin board to monitor the PCN information of the electronic product.

2. The computing device according to claim 1, wherein the computer-readable program further causes the at least one processor to:
delete the PCN information of the electronic product from the PCN database when the product information of the electronic product has been updated to the BOM.

3. The computing device according to claim 1, wherein the PCN information of each electronic product comprises a supplier ID, a product ID, a product name, and product change data of the electronic product.

4. The computing device according to claim 1, wherein the BOM of each electronic product comprises product design data of the electronic product, and the product design data of the electronic product comprise a product ID, a product name, a supplier ID, and product characteristic data of the electronic product.

5. The computing device according to claim 1, wherein the electronic bulletin board is displayed on a display device of the computing device, and displays the PCN information of each electronic product on the display device.

6. A method for automatically processing product change notice (PCN) of electronic products using a computing device, the computing device connected to a PCN database and a product design management (PDM) database, the method comprising:
creating bill of materials (BOMs) for the electronic products in the PDM database;
collecting PCN information of the electronic products sent from a supplier, and storing the PCN information of the electronic products in the PCN database;
searching PCN information of an electronic product from the PCN database at a regular time interval, and obtaining a product ID of the electronic product from the PCN information;
determining whether the product ID of the electronic product exists in the PDM database;
obtaining a BOM of the electronic product from the PDM database according to the product ID when the product ID of the electronic product exists in the PDM database;
determining whether the PCN information of the electronic product is qualified according to product information of the electronic product stored in the BOM;
updating the product information of the electronic product stored in the BOM according to the PCN information of the electronic product and saving the updated BOM in the PDM database when the PCN information of the electronic product is qualified; and
displaying the PCN information of the electronic product on an electronic bulletin board to monitor the PCN information of the electronic product.

7. The method according to claim 6, further comprising:
deleting the PCN information of the electronic product from the PCN database when the product information of the electronic product has been updated to the BOM.

8. The method according to claim 6, wherein the PCN information of each electronic product comprises a supplier ID, a product ID, a product name, and product change data of each electronic product.

9. The method according to claim 6, wherein the BOM of each electronic product comprises product design data of the electronic product, and the product design data of the electronic product comprise a product ID, a product name, a supplier ID, and product characteristic data of the electronic product.

10. The method according to claim 6, wherein the electronic bulletin board is displayed on a display device of the computing device, and displays the PCN information of each electronic product on the display device.

11. A non-transitory storage medium having stored thereon instructions that, when executed by at least one processor of a computing device, causes the processor to perform a method for automatically processing product change notice (PCN) of electronic products, the computing device connected to a PCN database and a product design management (PDM) database, the method comprising:
creating bill of materials (BOMs) for the electronic products in the PDM database;
collecting PCN information of the electronic products sent from a supplier, and storing the PCN information of the electronic products in the PCN database;
searching PCN information of an electronic product from the PCN database at a regular time interval, and obtaining a product ID of the electronic product from the PCN information;
determining whether the product ID of the electronic product exists in the PDM database;
obtaining a BOM of the electronic product from the PDM database according to the product ID when the product ID of the electronic product exists in the PDM database;
determining whether the PCN information of the electronic product is qualified according to product information of the electronic product stored in the BOM;
updating the product information of the electronic product stored in the BOM according to the PCN information of the electronic product and saving the updated BOM in the PDM database when the PCN information of the electronic product is qualified; and
displaying the PCN information of the electronic product on an electronic bulletin board to monitor the PCN information of the electronic product.

12. The storage medium according to claim 11, wherein the method further comprises:
deleting the PCN information of the electronic product from the PCN database when the product information of the electronic product has been updated to the BOM.

13. The storage medium according to claim 11, wherein the PCN information of each electronic product comprises a supplier ID, a product ID, a product name, and product change data of the electronic product.

14. The storage medium according to claim 11, wherein the BOM of each electronic product comprises product design data of the electronic product, and the product design data of the electronic product comprise a product ID, a product name, a supplier ID, and product characteristic data of the electronic product.

15. The storage medium according to claim 11, wherein the electronic bulletin board is displayed on a display device of the computing device, and displays the PCN information of each electronic product on the display device.
